(19) United States
(12) Patent Application Publication
(10) Pub. No.: US 2026/0092468 A1
(43) Pub. Date: Apr. 2, 2026

(54) GATE AND EJECTOR ROD THEREOF

(71) Applicant: Zhejiang Dongrui Industrial and Trading Co., Ltd., Jinhua City (CN)

(72) Inventor: Feihong XU, Jinhua City (CN)

(21) Appl. No.: 18/932,794

(22) Filed: Oct. 31, 2024

(30) Foreign Application Priority Data
Sep. 30, 2024 (CN) 2024223998613

(51) Int. Cl. E04H 17/00

(52) U.S. Cl. CPC E04H 17/013

(57) ABSTRACT

A gate and an ejector rod thereof are disclosed, the ejector rod includes a main plate, a first and a second side plate. A first and a second clamping protrusion are provided at two sides of the main plate. The first side plate is provided with a first clamping groove matched with the first clamping protrusion, and so is the second side plate. The main plate, the first and the second side plate are each processed into a respective arc structure, and one side of the main plate is detachably connected with the first side plate, and the other side of the main plate is detachably connected with the second side plate. After the ejector rod is assembled, welding is performed at joints of the first clamping groove and the first clamping protrusion, and of the second clamping groove and the second clamping protrusion.

### CROSS-REFERENCE TO RELATED APPLICATION

This Non-provisional application claims priority under 35 U.S.C. § 119(a) on Chinese Patent Application No(s). 202422399861.3 filed on Sep. 30, 2024, the entire contents of which are hereby incorporated by reference.

### TECHNICAL FIELD

The disclosure relates to the technical field of gate body processing, in particular to a gate and an ejector rod thereof.

### BACKGROUND ART

With improvement of modern living standards, more and more people pay attention to design of homes, in which wrought iron gates are increasingly used. The wrought iron gates not only have good aesthetic but also have good strength, which thus are increasingly used in residential places as gates of houses, and can not only provide enough aesthetic and thus improved overall architectural aesthetic feeling of the houses. Currently, ledges of the wrought iron gates on the market are usually in a square pipe structure. In processing, it is necessary to cut the square pipe with a required length manually, and then use a special device to bend and shape the square pipe, during which there will be elastic deformation, which causes the bent square pipe to have a larger processing error over another bent square pipe, affects overall aesthetics of the gates, and results in a high rejection rate.

### SUMMARY

In view of above technical problems, a gate and an ejector rod thereof are provided in the disclosure. A main plate, a first side plate and a second side plate are each processed into a respective arc structure with a required size in advance, and then one side of the main plate is detachably connected with the first side plate through a first clamping protrusion and a first clamping groove, and the other side of the main plate is detachably connected with the second side plate through a second clamping protrusion and a second clamping groove, thus reducing error in size processing and improving its yield.

A technical scheme adopted in the disclosure is as follows: an ejector rod of a gate includes a main plate, a first side plate and a second side plate respectively with an arc structure. A first clamping protrusion is provided at one side of the main plate, and a second clamping protrusion is provided at the other side of the main plate. The first side plate is provided with a first clamping groove matched with the first clamping protrusion, and the second side plate is provided with a second clamping groove matched with the second clamping protrusion.

Optionally, the ejector rod of the gate further includes a first chuck and a second chuck. One side of the first chuck is detachably connected with one end of the first side plate, the other side of the first chuck is detachably connected with one end of the second side plate; and one side of the second chuck is detachably connected with the other end of the first side plate, and the other side of the second chuck is detachably connected with the other end of the second side plate.

Optionally, a third clamping groove is provided at one side of the first chuck, a fourth clamping groove is provided at the other side of the first chuck; a fifth clamping groove is provided at one side of the second chuck, and a sixth clamping groove is provided at the other side of the second chuck. A third clamping projection matched with the third clamping groove is provided at one end of the first side plate, and a fourth clamping projection matched with the fifth clamping groove is provided at the other end of the first side plate; a fifth clamping projection matched with the fourth clamping groove is provided at one end of the second side plate, and a sixth clamping projection matched with the sixth clamping groove is provided at the other end of the second side plate.

Optionally, the main plate is provided with a plurality of through holes matched with a gate panel, and the plurality of through holes are arranged at intervals along a length direction of the main plate.

Optionally, the first clamping groove and the second clamping groove are located at middle parts of the first side plate and the second side plate respectively, that is, when the main plate is clamped with the first side plate and the second side plate, their cross sections form a shape like H, so that a bending radian of the main plate can be easily fixed.

Optionally, the main plate is in a form of a thin sheet, and thus has certain flexibility, and it can be bent at any angle to form a structure with one or more bends without processing and bending, and the one or more bends can have different bending directions, such as an S shape, a wave shape, etc. However, in related art, a method of bending a square pipe by using a special device as required can often only have one bending direction, for example, to make a semicircle, and if a shape with multiple bends such as an S shape is made, its raw material may be easily broken. Optionally, the first side plate and the second side plate are also in a form of a thin sheet, and their shapes are designed as required. In another feasible embodiment, the main plate can also be of a slightly thick plate structure, which can be processed and bent into an arc or curve structure with a required size as required.

A gate is further provided in the disclosure, which includes a first upright post, a second upright post, a bottom rod, a gate panel and the ejector rod of the gate described above. One end of the bottom rod and the first chuck are respectively detachably connected with the first upright post through screws, the other end of the bottom rod and the second chuck are respectively detachably connected with the second upright post through screws, a top surface of the gate panel is detachably connected with the main plate, and a bottom surface of the gate panel is detachably connected with the bottom rod through screws.

Optionally, a side of the first upright post facing the second upright post and a side of the second upright post facing the first upright post are respectively provided with a first through groove, and a connecting block is provided in the first through groove, and the first chuck and the second chuck are respectively connected with the connecting block through screws.

Optionally, a side wall of the first upright post and a side wall of the second upright post are respectively provided with a second through groove for the connecting block passing through, and the first through groove is communicated with the second through groove. The first through groove includes an inlet, an accommodating part and an outlet which are sequentially communicated. The connecting block is matched with the accommodating part, and diameters of the inlet and the outlet are respectively smaller than that of the accommodating part.

Optionally, the gate further includes a plug. The plug includes a connecting part and a limiting part connected with the connecting part. The connecting part is matched with the inlet, a diameter of the limiting part is larger than that of the inlet, the connecting part is provided with a buckle, and the buckle is matched with the accommodating part.

The disclosure has beneficial effects that: the main plate, the first side plate and the second side plate are each processed into a respective arc structure with a required size in advance, and then one side of the main plate is detachably connected with the first side plate through the first clamping protrusion and the first clamping groove, and the other side of the main plate is detachably connected with the second side plate through the second clamping protrusion and the second clamping groove, which facilitates assembling. After the ejector rod is assembled, welding is performed at joints of the first clamping groove and the first clamping protrusion, and of the second clamping groove and the second clamping protrusion, thus reducing error in size processing and improving its yield. Further, the ejector rod of the gate is only composed of the main plate, the first side plate and the second side plate, which replaces a traditional square pipe structure, simplifies the structure and reduces overall weight of the gate.

### BRIEF DESCRIPTION OF THE DRAWINGS

FIG. 1 is a schematic structural view of an ejector rod of a gate according to an embodiment of the disclosure;

FIG. 2 is a schematic structural view of a gate according to an embodiment of the disclosure; and

FIG. 3 is a schematic view of a first through groove and the second through groove of a gate according to an embodiment of the disclosure.

Reference numbers in the drawings are as follows: 1. Main Plate; 2. First Side Plate; 3. Second Side Plate; 4. First Clamping Protrusion; 5. Second Clamping Protrusion; 6. First Clamping Groove; 7. Second Clamping Groove; 8. First Chuck; 9. Second Chuck; 10. Third Clamping Groove; 11. Fifth Clamping Groove; 12. Third Clamping Protrusion; 13. Fourth Clamping Protrusion; 14. Fifth Clamping Protrusion; 15. Sixth Clamping Protrusion; 16. Through Hole; 17. First Upright Post; 18. Second Upright Post; 19. Bottom Rod; 20. First Through Groove; 21. Connecting Block; 22. Screw; 23. Second Through Groove; 24. Inlet; 25. Plug; 26. Connecting Part; 27. Limiting Part; 28. Buckle; 29. Long Rod; 30. Short Rod.

### DETAILED DESCRIPTION

The disclosure will be further described in detail with reference to the drawings and embodiments.

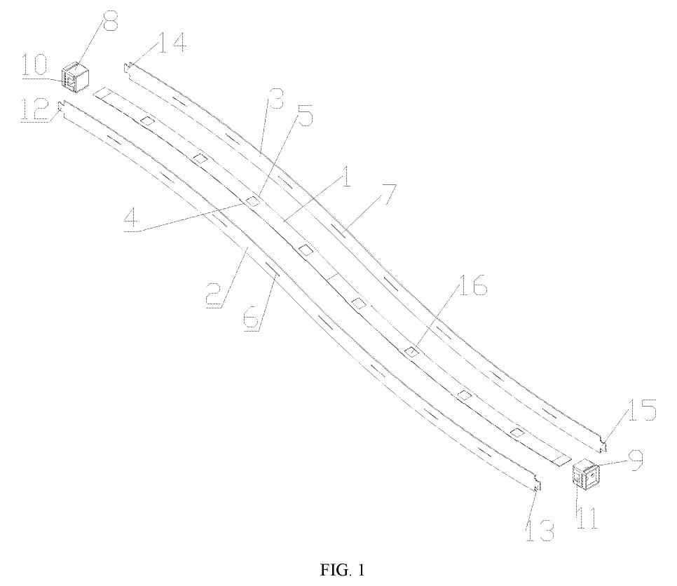

As shown in FIG. 1, an ejector rod of a gate is provided in this embodiment, which includes a main plate 1, a first side plate 2 and a second side plate 3 respectively with an arc structure. A first clamping protrusion 4 is provided at one side of the main plate 1, and a second clamping protrusion 5 is provided at the other side of the main plate 1. The first side plate 2 is provided with a first clamping groove 6 matched with the first clamping protrusion 4, and the second side plate 3 is provided with a second clamping groove 7 matched with the second clamping protrusion 5. The main plate, the first side plate and the second side plate are each processed into a respective arc or curve structure with a required size in advance, and then one side of the main plate is detachably connected with the first side plate through the first clamping protrusion and the first clamping groove, and the other side of the main plate is detachably connected with the second side plate through the second clamping protrusion and the second clamping groove, which facilitates assembling. After the ejector rod is assembled, welding is performed at joints of the first clamping groove and the first clamping protrusion, and of the second clamping groove and the second clamping protrusion, thus reducing error in size processing and improving its yield. Further, the ejector rod of the gate is only composed of the main plate, the first side plate and the second side plate, which replaces a traditional square pipe structure, simplifies the structure and reduces overall weight of the gate. In other embodiments, the main plate 1 can be detachably connected with the first side plate 2 and the second side plate 3 through screws 22.

As shown in FIG. 1, the ejector rod of the gate further includes a first chuck 8 and a second chuck 9. One side of the first chuck 8 is detachably connected with one end of the first side plate 2, the other side of the first chuck 8 is detachably connected with one end of the second side plate 3; and one side of the second chuck 9 is detachably connected with the other end of the first side plate 2, and the other side of the second chuck 9 is detachably connected with the other end of the second side plate 3. A third clamping groove 10 is provided at one side of the first chuck 8, a fourth clamping groove is provided at the other side of the first chuck 8; a fifth clamping groove 11 is provided at one side of the second chuck 9, and a sixth clamping groove is provided at the other side of the second chuck 9. A third clamping projection 12 matched with the third clamping groove 10 is provided at one end of the first side plate 2, and a fourth clamping projection 13 matched with the fifth clamping groove 11 is provided at the other end of the first side plate 2; a fifth clamping projection 14 matched with the fourth clamping groove is provided at one end of the second side plate 3, and a sixth clamping projection 15 matched with the sixth clamping groove is provided at the other end of the second side plate 3. The first chuck 8 and the second chuck 9 can also be connected with the first side plate 2 and the second side plate 3 respectively through screws 22. The first chuck 8 is matched with one end of the first side plate 2 and one end of the second side plate 3, and the second chuck 9 is matched with the other end of the first side plate 2 and the other end of the second side plate 3; and then welding is performed between the first clamping groove 6 and the first clamping projection 4, between the second clamping groove 7 and the second clamping projection 5, between the third clamping groove 10 and the third clamping projection 12, between the fourth clamping groove and the fifth clamping projection 14, between the fifth clamping groove 11 and the fourth clamping projection 13, and between the sixth clamping groove and the sixth clamping projection 15, thus reducing error in size processing and improving its yield. The main plate 1 is provided with a plurality of through holes 16 matched with a gate panel, and the plurality of through holes 16 are arranged at intervals along a length direction of the main plate 1. Further, the through hole 16 can be provided corresponding to the first clamping protrusion 4 and the second clamping protrusion 5 in position.

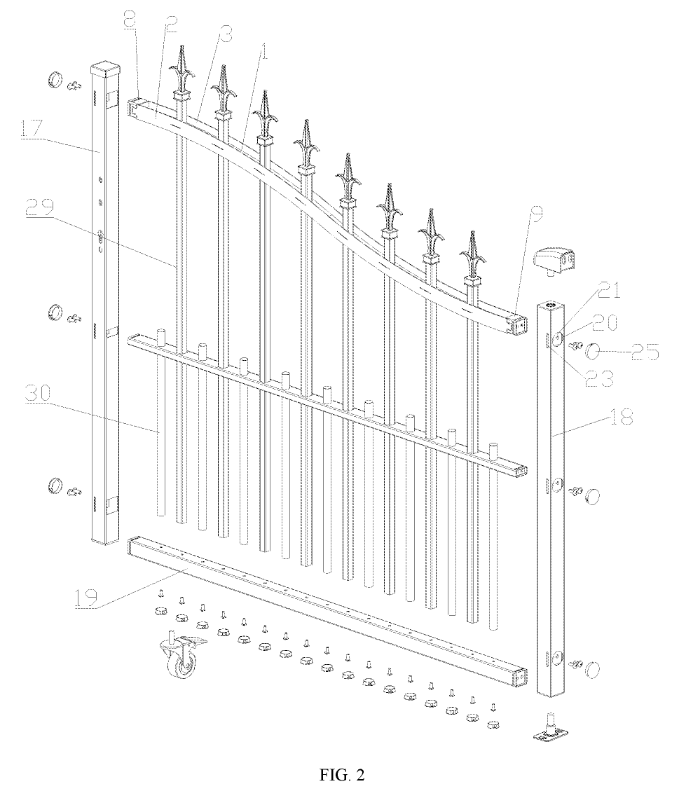

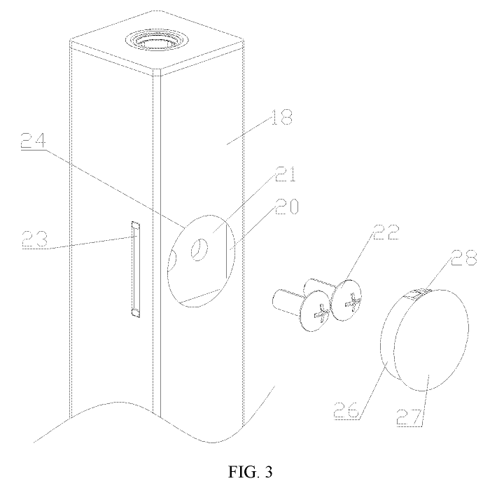

As shown in FIGS. 2 and 3, a gate is further provided in the disclosure, which includes a first upright post 17, a second upright post 18, a bottom rod 19, a gate panel and the ejector rod of the gate. One end of the bottom rod 19 and the first chuck 8 are respectively detachably connected with the first upright post 17 through screws 22, the other end of the bottom rod 19 and the second chuck 9 are respectively detachably connected with the second upright post 18 through screws 22, a top surface of the gate panel is detachably connected with the main plate 1, and a bottom surface of the gate panel is detachably connected with the bottom rod 19 through screws 22. The first upright post 17, the second upright post 18, the main plate 1, the bottom rod 19 and the gate panel are all connected by screws 22, which is with a simple and practical process and facilitates assembling, greatly reduces technical requirements for operators, improves production efficiency, and also reduces difficulty of transportation of the gate.

As shown in FIGS. 2 and 3 a side of the first upright post 17 facing the second upright post 18 and a side of the second upright post 18 facing the first upright post 17 are respectively provided with a first through groove 20, and a connecting block 21 is provided in the first through groove 20, and the first chuck 8 and the second chuck 9 are respectively connected with the connecting block 21 through screws 22. Two ends of the first upright post 17 are respectively provided with a first through groove 20, and two ends of the second upright post 18 are respectively provided with a first through groove 20. The first chuck 8 and the second chuck 9 are respectively matched with first through grooves 20 at top ends of the first upright post 17 and the second upright post 18, and the bottom rod 19 is respectively matched with first through grooves 20 at bottom ends of the first upright post 17 and the second upright post 18.

As shown in FIG. 3, a side wall of the first upright post 17 and a side wall of the second upright post 18 are respectively provided with a second through groove 23 for the connecting block 21 passing through, and the first through groove 20 is communicated with the second through groove 23. The first through groove 20 includes an inlet 24, an accommodating slot and an outlet which are sequentially communicated. The connecting block 21 is matched with the accommodating slot, and diameters of the inlet 24 and the outlet are respectively smaller than that of the accommodating slot. The connecting block 21 enters the first through groove 20 via the second through grooves 23 at the side wall of the first upright post 17 and the side wall of the second upright post 18, respectively, and is connected with the ejector rod or the bottom rod 19 by screws 22 through the connecting block 21 . Sizes of the inlet 24 and the outlet is configured to limit the connecting block 21. The gate further includes a plug 25. The plug 25 includes a connecting part 26 and a limiting part 27 connected with the connecting part 26. The connecting part 26 is matched with the inlet 24, a diameter of the limiting part 27 is larger than that of the inlet 24, the connecting part 26 is provided with a buckle 28, and the buckle 28 is matched with the accommodating slot. The gate panel can be composed of a plurality of long rods 29 and short rods 30, or composed of baffles and railings, or composed of a plurality of baffles, which can be selected by users according to their needs.

It can be understood that the specific embodiments described herein are only intended to explain related disclosures, but not to limit the disclosure. In addition, it should also be noted that for convenience of description, only the parts related to the disclosure are shown in the drawings. A plurality of technical schemes in the same embodiment and a plurality of technical schemes in different embodiments can be arranged and combined to form a new technical scheme without contradiction or conflict. Any equivalent structural transformation made by using the contents of this application specification and drawings, directly or indirectly applied to other related technical fields. Any equivalent transformation made with the specification of the present disclosure, which is directly or indirectly applied to other related technical fields, is included within the scope of the disclosure.

1. An ejector rod of a gate, comprising a main plate, a first side plate and a second side plate respectively with an arc structure, wherein a first clamping protrusion is provided at one side of the main plate, and a second clamping protrusion is provided at the other side of the main plate; the first side plate is provided with a first clamping groove matched with the first clamping protrusion, and the second side plate is provided with a second clamping groove matched with the second clamping protrusion.

2. The ejector rod of the gate according to claim 1, wherein the ejector rod of the gate further comprises a first chuck and a second chuck, one side of the first chuck being detachably connected with one end of the first side plate, the other side of the first chuck being detachably connected with one end of the second side plate; and one side of the second chuck being detachably connected with the other end of the first side plate, and the other side of the second chuck being detachably connected with the other end of the second side plate.

3. The ejector rod of the gate according to claim 2, wherein a third clamping groove is provided at one side of the first chuck, a fourth clamping groove is provided at the other side of the first chuck; a fifth clamping groove is provided at one side of the second chuck, and a sixth clamping groove is provided at the other side of the second chuck; a third clamping projection matched with the third clamping groove is provided at one end of the first side plate, and a fourth clamping projection matched with the fifth clamping groove is provided at the other end of the first side plate; a fifth clamping projection matched with the fourth clamping groove is provided at one end of the second side plate, and a sixth clamping projection matched with the sixth clamping groove is provided at the other end of the second side plate.

4. The ejector rod of the gate according to claim 1, wherein the main plate is provided with a plurality of through holes matched with a gate panel, the plurality of through holes being arranged at intervals along a length direction of the main plate.

5. A gate, comprising a first upright post, a second upright post, a bottom rod, a gate panel and the ejector rod of the gate, wherein one end of the bottom rod and the first chuck are respectively detachably connected with the first upright post through screws, the other end of the bottom rod and the second chuck are respectively detachably connected with the second upright post through screws, a top surface of the gate panel is detachably connected with the main plate, and the bottom surface of the gate panel is detachably connected with the bottom rod through screws；
wherein the ejector rod of the gate comprises a main plate, a first side plate and a second side plate respectively with an arc structure, wherein a first clamping protrusion is provided at one side of the main plate, and a second clamping protrusion is provided at the other side of the main plate; the first side plate is provided with a first clamping groove matched with the first clamping protrusion, and the second side plate is provided with a second clamping groove matched with the second clamping protrusion; wherein the ejector rod of the gate further comprises a first chuck and a second chuck, one side of the first chuck being detachably connected with one end of the first side plate, the other side of the first chuck being detachably connected with one end of the second side plate; and one side of the second chuck being detachably connected with the other end of the first side plate, and the other side of the second chuck being detachably connected with the other end of the second side plate.

6. The gate according to claim 5, wherein a side of the first upright post facing the second upright post and a side of the second upright post facing the first upright post are respectively provided with a first through groove, and a connecting block is provided in the first through groove, and the first chuck and the second chuck are respectively connected with the connecting block through screws.

7. The gate according to claim 6, wherein a side wall of the first upright post and a side wall of the second upright post are respectively provided with a second through groove for the connecting block passing through, and the first through groove is communicated with the second through groove; the first through groove comprising an inlet, an accommodating part and an outlet which are sequentially communicated, and the connecting block is matched with the accommodating part, and diameters of the inlet and the outlet are respectively smaller than a diameter of the accommodating part.

8. The gate according to claim 7, further comprising a plug, wherein the plug comprises a connecting part and a limiting part connected with the connecting part, the connecting part being matched with the inlet, a diameter of the limiting part being larger than a diameter of the inlet, the connecting part being provided with a buckle, and the buckle being matched with the accommodating part.

9. The ejector rod of the gate according to claim 1, wherein the first clamping groove and the second clamping groove are located at middle parts of the first side plate and the second side plate respectively.

10. The gate according to claim 5, wherein a third clamping groove is provided at one side of the first chuck, a fourth clamping groove is provided at the other side of the first chuck; a fifth clamping groove is provided at one side of the second chuck, and a sixth clamping groove is provided at the other side of the second chuck; a third clamping projection matched with the third clamping groove is provided at one end of the first side plate, and a fourth clamping projection matched with the fifth clamping groove is provided at the other end of the first side plate; a fifth clamping projection matched with the fourth clamping groove is provided at one end of the second side plate, and a sixth clamping projection matched with the sixth clamping groove is provided at the other end of the second side plate.

11. The gate according to claim 5, wherein the main plate is provided with a plurality of through holes matched with a gate panel, the plurality of through holes being arranged at intervals along a length direction of the main plate.

12. The gate according to claim 5, wherein the first clamping groove and the second clamping groove are located at middle parts of the first side plate and the second side plate respectively.
